(19) United States
(12) Patent Application Publication
(10) Pub. No.: US 2009/0233125 A1
(43) Pub. Date: Sep. 17, 2009

(54) ORGANIC LIGHT-EMITTING DEVICE INCLUDING ORGANIC LAYER INCLUDING ANTHRACENE DERIVATIVE COMPOUND

(75) Inventors: Kyung-Hoon CHOI, Suwon-si (KR); Kwan-Hee Lee, Suwon-si (KR); Min-Seung Chun, Suwon-si (KR); Choon-Won Lim, Suwon-si (KR); Mia-Hwa Park, Suwon-si (KR); Young-suck Choi, Suwon-si (KR); Young-Ho Park, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/048,704

(22) Filed: Mar. 14, 2008

(30) Foreign Application Priority Data
Mar. 14, 2008 (KR) 2007-25072

(51) Int. Cl. B32B 9/00; C09K 11/00

(52) U.S. Cl. 428/690

(57) ABSTRACT

An organic light-emitting device includes a first electrode; a second electrode; and an organic layer interposed between the first electrode and the second electrode, the organic layer including one or more anthracene derivative compounds represented by Formula 1 below and optionally an ionic metal complex:

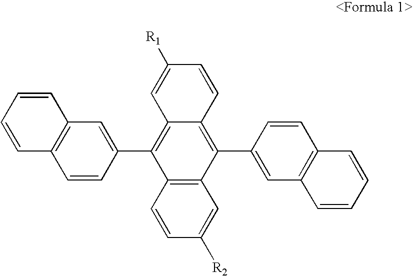

wherein R₁ and R₂ are each independently a hydrogen atom, a substituted or unsubstituted C1-C30 alkyl group, a substituted or unsubstituted C1-C30 alkoxy group, a substituted or unsubstituted C6-C30 aryl group, a substituted or unsubstituted C6-C30 aryloxy group, a substituted or unsubstituted C4-C30 heteroaryl group, a substituted or unsubstituted C6-C30 condensed polycyclic group, a hydroxyl group, halogen, a cyano group, or a substituted or unsubstituted amino group.

### CROSS-REFERENCE TO RELATED APPLICATION

This application claims the benefit of Korean Patent Application No. 2007-25072, filed Mar. 14, 2007 in the Korean Intellectual Property Office, the disclosure of which is incorporated herein by reference.

### BACKGROUND OF THE INVENTION

1. Field of the Invention

Aspects of the present invention relate to an organic light-emitting device that includes either an anthracene derivative compound and an ionic metal complex or two or more different anthracene derivative compounds. More particularly, aspects of the present invention relate to an organic light-emitting device featuring high efficiency, a low driving voltage, high brightness, and long lifetime, by virtue of using a material having electrical stability and good electron transport capability.

Aspects of the present invention relate to a prerequisite technology for developing high-quality organic light-emitting devices that have improved power consumption and lifetime characteristics.

2. Description of the Related Art

Organic light-emitting devices are devices that emit light by the recombination of electrons and holes in an organic layer interposed between two electrodes when a current is supplied to the organic layer. Examples of organic light-emitting devices are illustrated schematically in FIGS. 1A to 1C. Organic light-emitting devices have advantages such as high image quality, a rapid response speed, and a wide viewing angle, and thus, can embody lightweight and thin information display apparatuses. By virtue of such advantages, the organic light-emitting device technology has started to grow rapidly. Recently, the application field of organic light-emitting devices has expanded beyond mobile phones to other high-quality information display apparatuses.

With the rapid growth of organic light-emitting device technology, organic light-emitting devices should eventually compete with other information display devices, such as TFT-LCDs, in terms of science and industrial technology. However, conventional organic light-emitting devices still technical limitations in terms of efficiency, lifetime, and power consumption of the devices, which significantly affect quantitative and qualitative growth of the devices.

### SUMMARY OF THE INVENTION

Aspects of the present invention provide an organic light-emitting device capable of enhancing lifetime, brightness, and power consumption efficiency.

According to an embodiment of the present invention, there is provided an organic light-emitting device comprising: a first electrode; a second electrode; and an organic layer interposed between the first electrode and the second electrode, the organic layer comprising one or more anthracene derivative compounds represented by Formula 1 below and optionally an ionic metal complex:

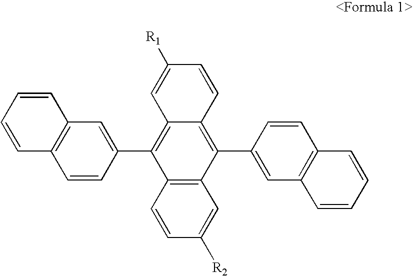

wherein R₁ and R₂ are each independently a hydrogen atom, a substituted or unsubstituted C1-C30 alkyl group, a substituted or unsubstituted C1-C30 alkoxy group, a substituted or unsubstituted C6-C30 aryl group, a substituted or unsubstituted C6-C30 aryloxy group, a substituted or unsubstituted C4-C30 heteroaryl group, a substituted or unsubstituted C6-C30 condensed polycyclic group, a hydroxyl group, halogen, a cyano group, or a substituted or unsubstituted amino group.

According to an aspect of the present invention, a mixture of an anthracene derivative compound and an ionic metal complex or a mixture of two or more different anthracene derivative compounds used in an organic light-emitting device has good electron transport capability, and thus, can be efficiently used as an organic layer forming material, thereby producing an organic light-emitting device with high efficiency, a low driving voltage, high brightness, and a long lifetime.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A through 1C are schematic sectional views illustrating organic light-emitting devices according to embodiments of the present invention;

FIG. 2 is a graph illustrating current densities of organic light-emitting devices manufactured in Examples 1-2 and Comparative Example 1;

FIG. 3 is a graph illustrating efficiency characteristics of the organic light-emitting devices manufactured in Examples 1-2 and Comparative Example 1; and

FIG. 4 is a graph illustrating lifetime characteristics of the organic light-emitting devices manufactured in Examples 1-2 and Comparative Example 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention provide an organic light-emitting device including: a first electrode; a second electrode; and an organic layer interposed between the first electrode and the second electrode. The organic layer includes one or more anthracene derivative compounds represented by Formula 1 below and optionally, an ionic metal complex:

The organic layer includes either an anthracene derivative compound represented by Formula 1 below and an ionic metal complex or two or more different anthracene derivative compounds represented by Formula 1 below:

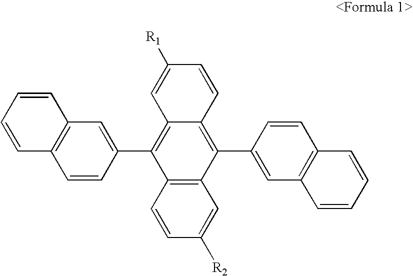

wherein R₁ and R₂ are each independently a hydrogen atom, a substituted or unsubstituted C1-C30 alkyl group, a substituted or unsubstituted C1-C30 alkoxy group, a substituted or unsubstituted C6-C30 aryl group, a substituted or unsubstituted C6-C30 aryloxy group, a substituted or unsubstituted C4-C30 heteroaryl group, a substituted or unsubstituted C6-C30 condensed polycyclic group, a hydroxyl group, halogen, a cyano group, or a substituted or unsubstituted amino group.

Preferably, R₁ and R₂ are each independently selected from the group consisting of a phenyl group, a C1-C5 alkylphenyl group, a C1-C5 alkoxyphenyl group, a cyanophenyl group, a phenoxyphenyl group, a halophenyl group, a naphthyl group, a C1-C5 alkylnaphthyl group, a C1-C5 alkoxynaphthyl group, a cyanonaphthyl group, a halonaphthyl group, an anthracenyl group, a fluorenyl group, a carbazolyl group, a C1-C5 alkylcarbazolyl group, a biphenyl group, a C1-C5 alkylbiphenyl group, a C1-C5 alkoxybiphenyl group, and a pyridinyl group.

More preferably, R₁ and R₂ are each independently selected from the group consisting of a phenyl group, an ethylphenyl group, an ethylbiphenyl group, an o-, m- or p-fluorophenyl group, a dichlorophenyl group, a dicyanophenyl group, a trifluoromethoxyphenyl group, an o-, m-, or p-tolyl groups, a mesityl group, a phenoxyphenyl group, a dimethylphenyl group, a (N,N′-dimethyl)aminophenyl group, a (N,N′-diphenyl)aminophenyl group, a pentalenyl group, a naphthyl group, a methylnaphthyl group, an anthracenyl group, an azulenyl group, a heptalenyl group, an acenaphthylenyl group, a fluorenyl group, an anthraquinolyl group, a phenanthryl group, a triphenylenyl group, a pentaphenyl group, a hexaphenyl group, and a carbazolyl group.

Examples of a C1-C20 alkyl group in Formula 1 include methyl, ethyl, propyl, isobutyl, sec-butyl, pentyl, iso-amyl, and hexyl. The C1-C20 alkyl group may be unsubstituted or at least one hydrogen atom of the alkyl group may be substituted by a halogen atom, a hydroxy group, a nitro group, a cyano group, an amino group, an amidino group, hydrazine, hydrazone, a carboxyl group or its salt, a sulfonyl group or its salt, a phosphonyl group or its salt, a C1-C30 alkyl group, a C1-C30 alkenyl group, a C1-C30 alkynyl group, a C6-C30 aryl group, a C7-C30 arylalkyl group, a C2-C20 heteroaryl group, or a C3-C30 heteroarylalkyl group.

Examples of a C1-C20 alkoxy group in Formula 1 include methoxy, ethoxy, phenyloxy, cyclohexyloxy, naphthyloxy, isopropyloxy, and diphenyloxy. The C1-C20 alkoxy group may be unsubstituted or at least one hydrogen atom of the alkoxy group may be substituted by the same substituents as those recited in the above definition of the alkyl group.

The term “C6-C20 aryl group” in Formula 1 refers to an aromatic carbocyclic system containing one or more rings. The rings may be attached to each other to form a pendant group or may be fused. The C6-C20 aryl group may be unsubstituted or at least one hydrogen atom of the aryl group may be substituted by the same substituents as those recited in the above definition of the alkyl group.

The aryl group may be a phenyl group, an ethylphenyl group, an ethylbiphenyl group, an o-, m-, or p-fluorophenyl group, a dichlorophenyl group, a dicyanophenyl group, a trifluoromethoxyphenyl group, an o-, m-, or p-tolyl group, an o-, m-, or p-cumenyl group, a mesityl group, a phenoxyphenyl group, a (α,α-dimethylbenzene)phenyl group, a (N,N′-dimethyl)aminophenyl group, a (N,N′-diphenyl)aminophenyl group, a pentalenyl group, an indenyl group, a naphthyl group, a methylnaphthyl group, an anthracenyl group, an azulenyl group, a heptalenyl group, an acenaphthylenyl group, a phenalenyl group, a fluorenyl group, an anthraquinolyl group, a methylanthryl group, a phenanthryl group, a triphenylene group, a pyrenyl group, a chrysenyl group, an ethyl-chrysenyl group, a picenyl group, a perylenyl group, a chloroperylenyl group, a pentaphenyl group, a pentacenyl group, a tetraphenylenyl group, a hexaphenyl group, a hexacenyl group, a rubicenyl group, a coronenyl group, a trinaphthylenyl group, a heptaphenyl group, a heptacenyl group, a pyranthrenyl group, an ovalenyl group, a carbazolyl group, etc.

Examples of an aryloxy group in Formula 1 include phenyloxy, naphthyleneoxy, and diphenyloxy. At least one hydrogen atom of the aryloxy group may be substituted by the same substituents as those recited in the above definition of the alkyl group.

The term “heteroaryl group” in Formula 1 refers to a monovalent or divalent monocyclic or bicyclic aromatic organic compound of 6-30 carbon atoms containing one, two or three heteroatoms selected from N, O, P, and S. The heteroaryl group may be unsubstituted or at least one hydrogen atom of the heteroaryl group may be substituted by the same substituents as those recited in the above definition of the alkyl group.

Examples of the heteroaryl group include a pyrazolyl group, an imidazolyl group, an oxazolyl group, a thiazolyl group, a triazolyl group, a tetrazolyl group, an oxadiazolyl group, a pyridinyl group, a pyridazinyl group, a pyrimidinyl group, a triazinyl group, a carbazolyl group, an indolyl group, etc.

In particular, as non-limiting examples, the compound of Formula 1 may be selected from compounds represented by Formulae 2 through 9 below:

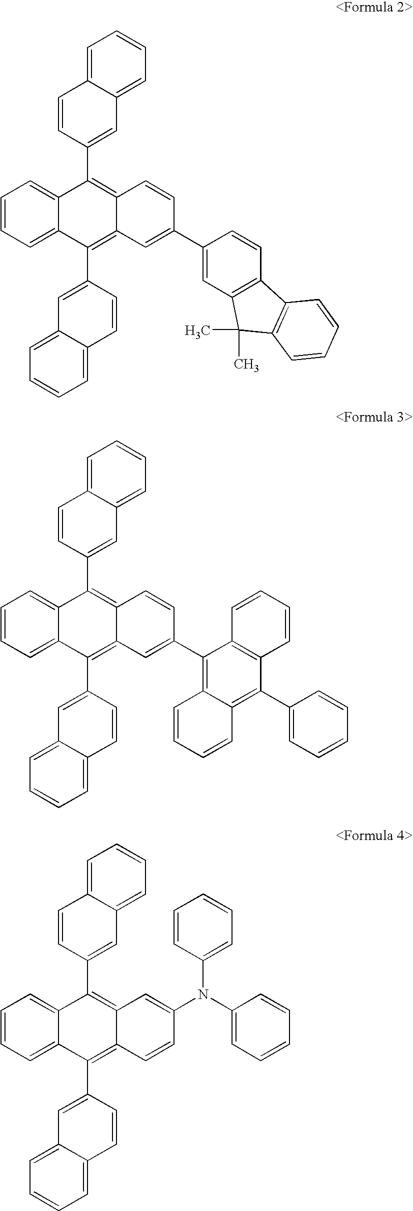

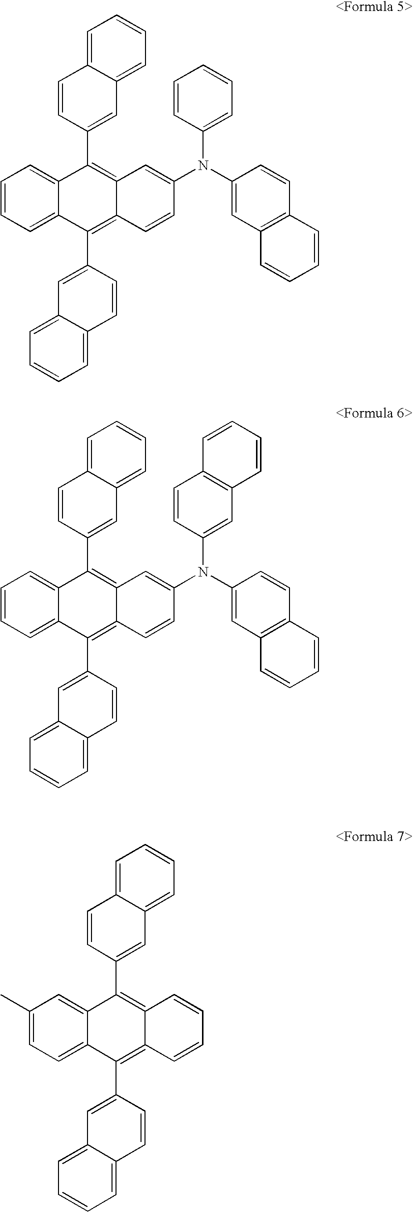

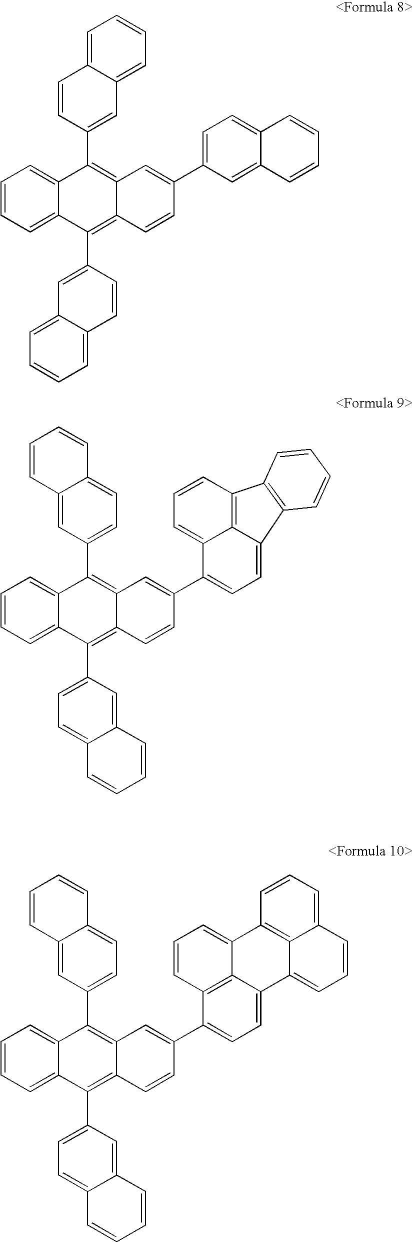

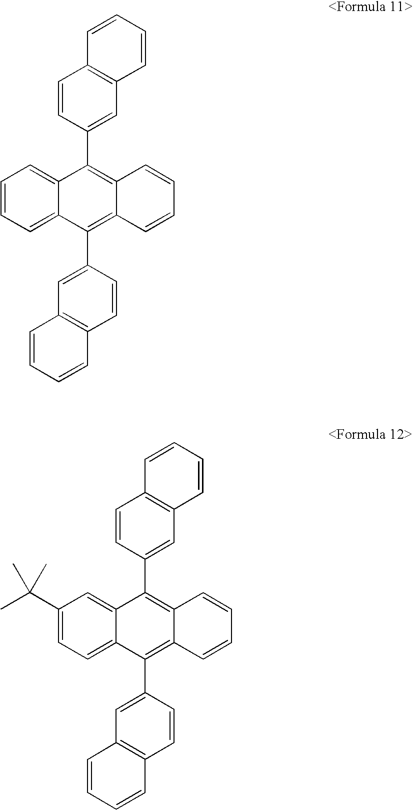

When the organic layer includes two or more different anthracene derivative compounds represented by Formula 1 above, for example, those two or more different anthracene derivative compounds can be selected from the group consisting of the compounds represented by Formulae 2-10 above.

The ionic metal complex that can be used in the organic light-emitting device according to aspects of the present invention may be selected from compounds containing a monovalent or divalent center metal M or M′, such as compounds represented by Formulae 13 through 15 below:

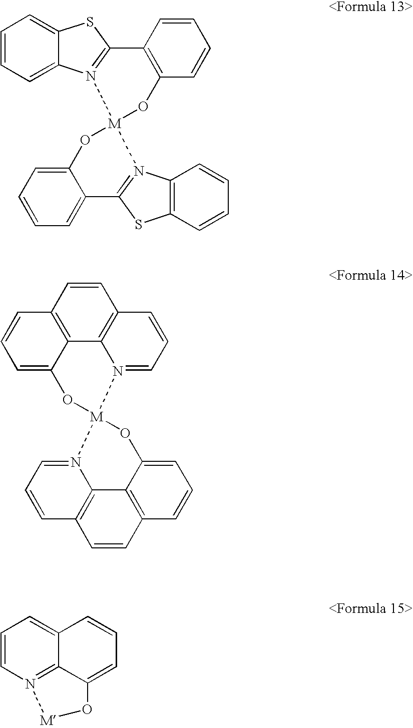

wherein M and M′ are each a monovalent or divalent metal.

For example, M and M′ may each be Li, Na, Ca, Cs, Be, Mg, Zn, or the like. As more specific, non-limiting examples, the ionic metal complex may be a lithium quinolinolate (LiQ) metal complex, a sodium quinolinolate (NaQ) metal complex, or a cesium quinolinolate (CsQ) metal complex.

In the embodiment of the organic light-emitting device comprising the anthracene derivative compound of Formula 1 and the ionic metal complex, a weight ratio of the anthracene derivative compound of Formula 1 and the ionic metal complex may be 5:95 to 95:5. If the weight ratio of the anthracene derivative compound of Formula 1 and the ionic metal complex is less than 5:95, i.e., if the content of the anthracene derivative compound of Formula 1 is too small, the lifetime of the organic light-emitting device may be reduced. On the other hand, if the weight ratio of the anthracene derivative compound of Formula 1 and the ionic metal complex exceeds 95:5, i.e., if the content of the ionic metal complex is too small, the driving voltage of the organic light-emitting device may be increased.

In the embodiment of the organic light-emitting device comprising two or more different anthracene derivatives, a weight ratio of the two or more different anthracene derivative compounds of Formula 1 may be 5:95 to 95:5. If the content of one of the two or more different anthracene derivative compounds of Formula 1 is too high (greater than 95:5) or too low (less than 5:95), the lifetime of the organic light-emitting device may be reduced or a driving voltage may be increased.

The organic light-emitting device according to aspects of the present invention can be structured in various ways. The organic light-emitting device may further include at least one organic layer selected from the group consisting of an electron transport layer, an electron injection layer, a hole blocking layer, an emitting layer, an electron blocking layer, a hole injection layer, and a hole transport layer, between the first electrode and the second electrode. As described above, such an organic layer may include either a mixture of an anthracene derivative compound of Formula 1 and an ionic metal complex or a mixture of two or more different anthracene derivative compounds of Formula 1. For example, an organic layer including either a mixture of an anthracene derivative compound of Formula 1 and an ionic metal complex or a mixture of two or more different anthracene derivative compounds of Formula 1 may be an electron transport layer or an electron injection layer, but is not limited thereto.

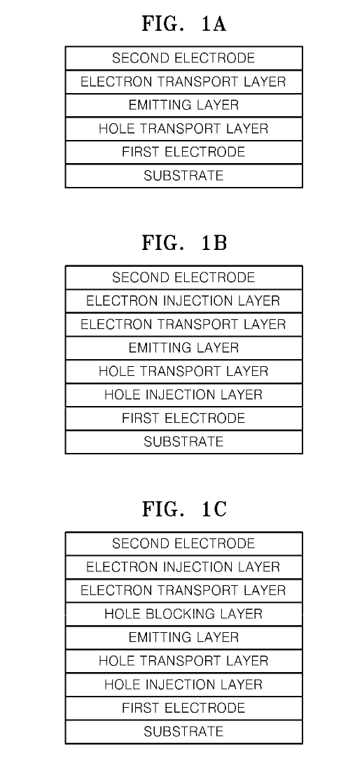

In more detail, organic light-emitting devices according to various embodiments of the present invention are illustrated in FIGS. 1A, 1B, and 1C. Referring to FIG. 1A, an organic light-emitting device has a first electrode/hole transport layer/emitting layer/electron transport layer/second electrode structure. Referring to FIG. 1B, an organic light-emitting device has a first electrode/hole injection layer/hole transport layer/emitting layer/electron transport layer/electron injection layer/second electrode structure. Referring to FIG. 1C, an organic light-emitting device has a first electrode/hole injection layer/hole transport layer/emitting layer/hole blocking layer/electron transport layer/electron injection layer/second electrode structure. Here, the emitting layer, the electron transport layer, or the electron injection layer may include an anthracene derivative compound of Formula 1.

Hereinafter, a method of manufacturing an organic light-emitting device according to an embodiment of the present invention will be described with reference to FIG. 1C.

First, a first electrode is formed on a substrate by deposition or sputtering using a first electrode material with a high work function. The first electrode may be an anode, and the substrate may be a substrate commonly used in organic light-emitting devices. As non-limiting examples, the substrate may be a glass or transparent plastic substrate that has excellent mechanical strength, thermal stability, transparency, surface smoothness, handling property, and water repellency. The first electrode material may be a transparent material having good conductivity, e.g., indium tin oxide (ITO), indium zinc oxide (IZO), tin oxide (SnO₂), or zinc oxide (ZnO).

Next, a hole injection layer (HIL) may be formed on the first electrode using any one of various methods, e.g., vacuum deposition, spin-coating, casting, or a Langmuir-Blodgett (LB) method.

When forming the hole injection layer using a vacuum deposition process, the deposition conditions vary according to the type of hole injection layer material, the structure and thermal characteristics of the hole injection layer, etc. For example, the hole injection layer may be deposited to a thickness of 10 Å to 5 μm at a deposition rate of 0.01 to 100 Å/sec, at a temperature of 100 to 500° C., and in a vacuum level of 10⁻⁸ to 10⁻³ torr.

The hole injection layer material is not particularly limited, and may be a phthalocyanine compound (e.g., copper phthalocyanine) disclosed in U.S. Pat. No. 4,356,429, a Starburst-type amine derivative (e.g., TCTA, m-MTDATA, m-MTDAPB) disclosed in Advanced Material, 6, p. 677 (1994), or the like. m-MTDATA is represented by the following formula:

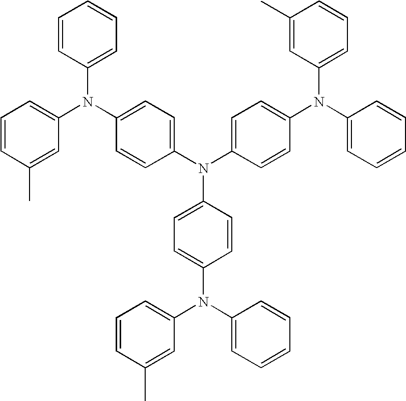

Next, a hole transport layer (HTL) may be formed on the hole injection layer using any one of various methods, e.g., vacuum deposition, spin-coating, casting, or LB method. When forming the hole transport layer using vacuum deposition, the deposition conditions vary according to the type of a used compound, but are generally almost the same as those used for the formation of the hole injection layer.

The hole transport layer material is not particularly limited and may be optionally selected from known materials used in hole transport layers, e.g., a carbazole derivative such as N-phenylcarbazole or polyvinylcarbazole; an amine derivative having an aromatic fused ring such as N,N′-bis(3-methylphenyl)-N,N′-diphenyl-[1,1-biphenyl]-4,4′-diamine (TPD) or N,N′-di(naphthalene-1-yl)-N,N′-diphenylbenzidine (α-NPD); etc. α-NPD is represented by the following formula:

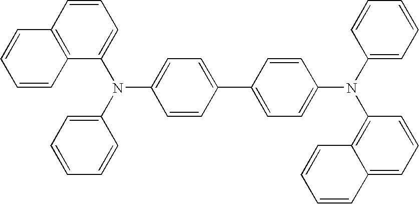

Next, an emitting layer (EML) may be formed on the hole transport layer using vacuum deposition, spin-coating, casting, an LB method, or the like. When forming the emitting layer using vacuum deposition, the deposition conditions vary according to the type of compound used, but are generally about the same as those used for the formation of the hole injection layer.

The emitting material is not particularly limited and may be optionally selected from known emitting materials, known host materials, and known dopant materials. For example, a host material may be GGH01, GGH02, GDI1403 (Gracel Co., Ltd.), Alq₃, CBP (4,4′-N,N′-dicarbazole-biphenyl), or the like. As for a dopant, a fluorescent dopant may be GGD01, GGD02 (Gracel Co., Ltd.), C545T (Hayashibara Co., Ltd.), or the like, and a phosphorescent dopant may be a red phosphorescent dopant, e.g., PtOEP, RD25, RD61 (UDC), a green phosphorescent dopant, e.g., Ir(PPy)₃(PPy=2-phenylpyridine), TLEC025, TLEC027 (Takasago Co., Ltd.), or a blue phosphorescent dopant, e.g., F2Irpic. Moreover, a dopant represented by the following formula may also be used:

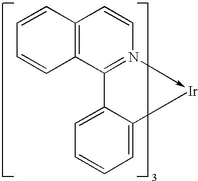

The doping concentration of the dopant is not particularly limited. Generally, the amount of dopant may be 0.01 to 15 parts by weight based on 100 parts by weight of the host and the dopant.

When the emitting layer includes a phosphorescent dopant, a hole blocking layer (HBL) may be further formed on the hole transport layer using vacuum deposition or spin-coating in order to prevent the diffusion of triplet excitons or holes into an electron transport layer. An available hole blocking material may be used, such as, for example, an oxadiazole derivative, a triazole derivative, a phenanthroline derivative, a hole blocking material disclosed in JP 11-329734(A1), BCP, or the like.

Next, an electron transport layer (ETL) is formed using any one of various methods, e.g., vacuum deposition, spin-coating, or casting. The electron transport layer material may be an anthracene derivative compound of Formula 1 capable of enhancing electron transport capability. The electron transport layer material may also be a known material, e.g., a quinoline derivative, such as, for example, tris(8-quinolinolate)aluminum (Alq3).

As a non-limiting example, the electron transport layer (ETL) may be formed to a thickness of 5 to 70 nm. If the thickness of the electron transport layer is less than 5 nm, a balance between holes and electrons may not be maintained, thereby lowering efficiency. On the other hand, if the thickness of the electron transport layer exceeds 70 nm, current characteristics may be lowered, thereby increasing a driving voltage.

Next, an electron injection layer (EIL) may be formed on the electron transport layer in order to facilitate the injection of electrons from a cathode. The electron injection layer material is not particularly limited. For example, the electron injection layer material may be LiF, NaCl, CsF, Li₂O, BaO, or the like. The deposition conditions of the hole blocking layer (HBL), the electron transport layer (ETL), and the electron injection layer (EIL) vary according to the types of compounds used, but are generally about the same as those used for the formation of the hole injection layer.

Finally, a second electrode may be formed on the electron injection layer using vacuum deposition or sputtering using a second electrode forming material. The second electrode may be used as a cathode. The second electrode forming material may be a metal or alloy with a low work function, an electroconductive compound, or a mixture thereof. For example, the second electrode forming material may be lithium (Li), magnesium (Mg), aluminum (Al), aluminum-lithium (Al—Li), calcium (Ca), magnesium-indium (Mg—In), magnesium-silver (Mg—Ag), etc. The second electrode may also be a transmissive cathode formed of ITO or IZO to provide a front-emission type device.

An organic light-emitting device according to aspects of the present invention can be variously structured, and the structure including a first electrode, a hole injection layer (HIL), a hole transport layer (HTL), an emitting layer (EML), a hole blocking layer (HBL), an electron transport layer (ETL), an electron injection layer (EIL), and a second electrode, as illustrated in FIG. 1C is merely a non-limiting example. If necessary, one or two intermediate layers may be additionally formed. Moreover, structures illustrated in FIGS. 1A and 1B may be used.

Hereinafter, Synthesis Examples of a compound (hereinafter, referred to as “compound 2”) represented by Formula 2 and a compound (hereinafter, referred to as “compound 3”) represented by Formula 3 above and Examples will be described, but the present invention is not limited to the following examples.

### EXAMPLES

### Synthesis Example 1

An intermediate A was synthesized according to Reaction Scheme 1 below.

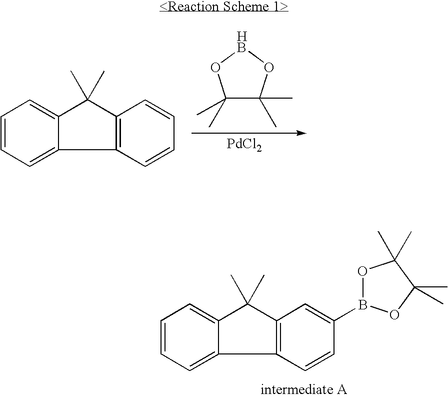

Compound 2 was synthesized using the intermediate A according to Reaction Scheme 2 below:

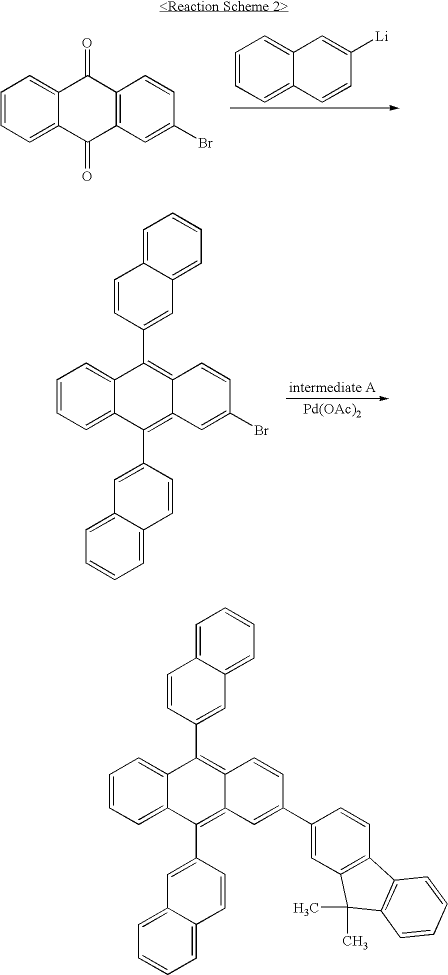

### Synthesis Example 2

Intermediate B was synthesized according to Reaction Scheme 3 below.

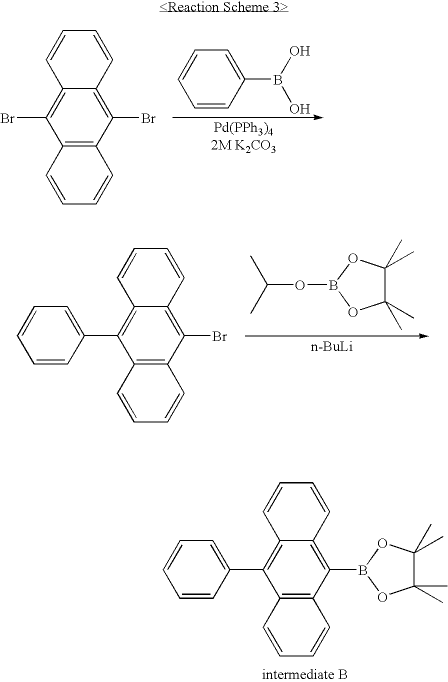

Compound 3 was synthesized according to Reaction Scheme 2 above using intermediate B instead of intermediate A.

### Example 1

Organic light-emitting devices were manufactured using a mixture of compound 2 synthesized in Synthesis Example 1 and sodium quinolinolate (NaQ) (weight ratio: 1:1) as an electron transport layer material to provide the following structure: m-MTDATA(750 Å)/α-NPD(150 Å)/GBHO2(300 Å):GBD32(3%)/electron transport layer (200 Å)/LiQ(10 Å)/Al(3000 Å).

A 15 Ω/cm² ITO glass substrate (Corning, 1200 Å) was cut into pieces of 50 mm×50 mm×0.7 mm in size, followed by ultrasonic cleaning in isopropyl alcohol and pure water (5 minutes for each) and UV/ozone cleaning (30 minutes) to form anodes. Then, m-MTDATA was vacuum-deposited to a thickness of 750 Å on the anodes to form a hole injection layer, and α-NPD was vacuum-deposited to a thickness of 150 Å on the hole injection layer to form a hole transport layer. Then, GBH02 (Gracel Co., Ltd.) as a blue fluorescent host and GBD32 (Gracel Co., Ltd.) as a dopant (weight ratio(%): 97:3) were vacuum-deposited to a thickness of 300 Å on the hole transport layers to form an emitting layer. Then, a mixture of the compound 2 and NaQ was vacuum-deposited to a thickness of 200 Å on the emitting layer to form the electron transport layer. LiQ (10 Å, electron injection layers) and Al (3000 Å, cathodes) were sequentially vacuum-deposited on the electron transport layers to form an LiQ/Al electrode. This completed the manufacture of an organic light-emitting device.

### Example 2

Organic light-emitting devices were manufactured in the same manner as in Example 1 except that a mixture of compound 2 synthesized in Synthesis Example 1 and compound 3 synthesized in Synthesis Example 2 (weight ratio: 1:1) was vacuum-deposited to form the electron transport layer.

### Comparative Example 1

Organic light-emitting devices were manufactured in the same manner as in Example 1 except that Alq3 was used as an electron transport layer material, thereby providing the following structure:

m-MTDATA(750 Å)/α-NPD(150 Å)/GBHO2(300 Å):GBD32(3%)/Alq3(200 Å)/LiF(80 Å)/Al(3000 Å).

### Evaluation Example 1

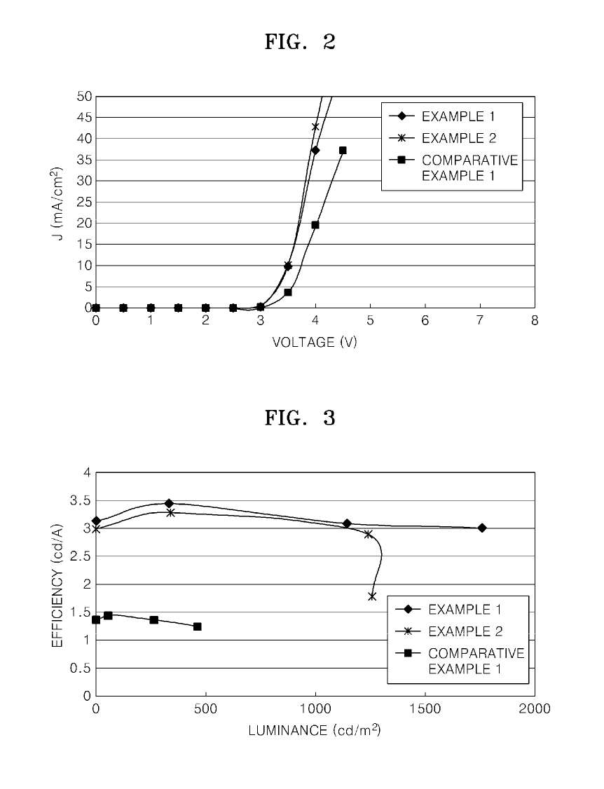

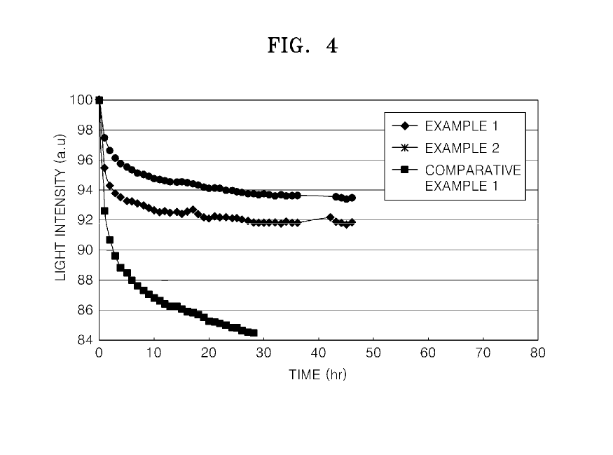

The current density, efficiency, and lifetime characteristics of the organic light-emitting devices manufactured in Examples 1 and 2 and Comparative Example 1 were evaluated. FIG. 2 is a graph illustrating current densities, FIG. 3 is a graph illustrating efficiency characteristics, and FIG. 4 is a graph illustrating lifetime characteristics of the organic light-emitting devices of Examples 1 and 2 and Comparative Example 1. The current density was evaluated using Source Measurement Unit 238 (Keithley), the efficiency characteristics were evaluated using PR650 (Photo Research Inc.), and the lifetime characteristics were evaluated using Polaronix M6000 (Mcscience).

As shown in FIGS. 2-4, a mixture of an anthracene derivative compound and an ionic metal complex or a mixture of two or more different anthracene derivative compounds used in an organic light-emitting device according to aspects of the present invention has good electron transport capability, and thus, can be efficiently used as an organic layer forming material, thereby producing an organic light-emitting device with high efficiency, a low driving voltage, high brightness, and a long lifetime.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An organic light-emitting device comprising:
a first electrode;
a second electrode; and
an organic layer interposed between the first electrode and the second electrode, the organic layer comprising two or more anthracene derivative compounds represented by Formula 1 below: 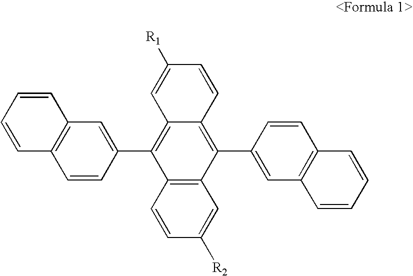
wherein R₁ and R₂ are each independently a hydrogen atom, a substituted or unsubstituted C1-C30 alkyl group, a substituted or unsubstituted C1-C30 alkoxy group, a substituted or unsubstituted C6-C30 aryl group, a substituted or unsubstituted C6-C30 aryloxy group, a substituted or unsubstituted C4-C30 heteroaryl group, a substituted or unsubstituted C6-C30 condensed polycyclic group, a hydroxyl group, halogen, a cyano group, or a substituted or unsubstituted amino group.

2. The organic light-emitting device of claim 1, wherein the organic layer comprises two different anthracene derivative compounds represented by Formula 1 and wherein the weight ratio of the two different anthracene derivative compounds is 5:95 to 95:5.

3. The organic light-emitting device of claim 1, wherein R₁ and R₂ are each independently selected from the group consisting of a phenyl group, a C1-C5 alkylphenyl group, a C1-C5 alkoxyphenyl group, a cyanophenyl group, a phenoxyphenyl group, a halophenyl group, a naphthyl group, a C1-C5 alkylnaphthyl group, a C1-C5 alkoxynaphthyl group, a cyanonaphthyl group, a halonaphthyl group, an anthracenyl group, a fluorenyl group, a carbazolyl group, a C1-C5 alkylcarbazolyl group, a biphenyl group, a C1-C5 alkylbiphenyl group, a C1-C5 alkoxybiphenyl group, and a pyridinyl group.

4. The organic light-emitting device of claim 1, wherein R₁ and R₂ are each independently selected from the group consisting of a phenyl group, an ethylphenyl group, an ethylbiphenyl group, an o-, m- or p-fluorophenyl group, a dichlorophenyl group, a dicyanophenyl group, a trifluoromethoxyphenyl group, an o-, m-, or p-tolyl groups, a mesityl group, a phenoxyphenyl group, a dimethylphenyl group, a (N,N′-dimethyl)aminophenyl group, a (N,N′-diphenyl)aminophenyl group, a pentalenyl group, a naphthyl group, a methylnaphthyl group, an anthracenyl group, an azulenyl group, a heptalenyl group, an acenaphthylenyl group, a fluorenyl group, an anthraquinolyl group, a phenanthryl group, a triphenylenyl group, a pentaphenyl group, a hexaphenyl group, and a carbazolyl group.

5. The organic light-emitting device of claim 4, wherein the anthracene derivative compounds of Formula 1 are selected from compounds represented by Formulae 2 through 12 below:

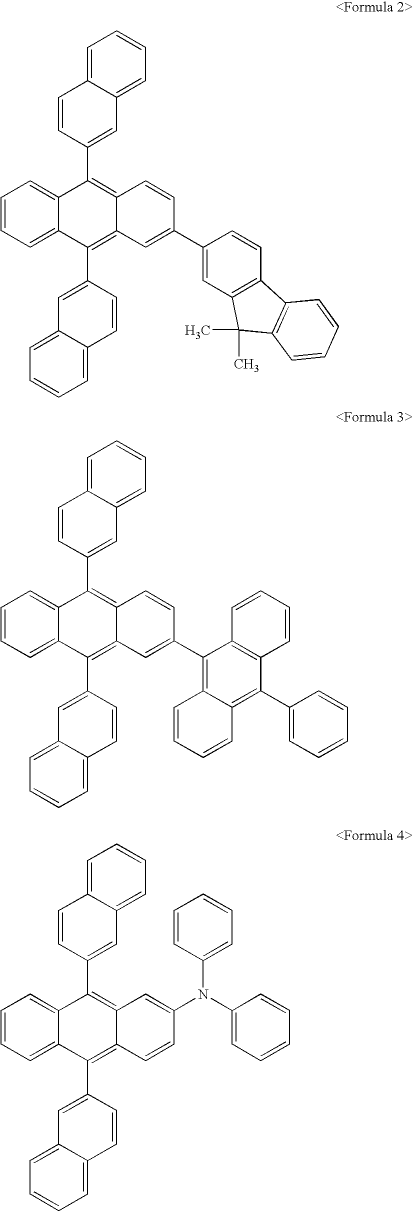

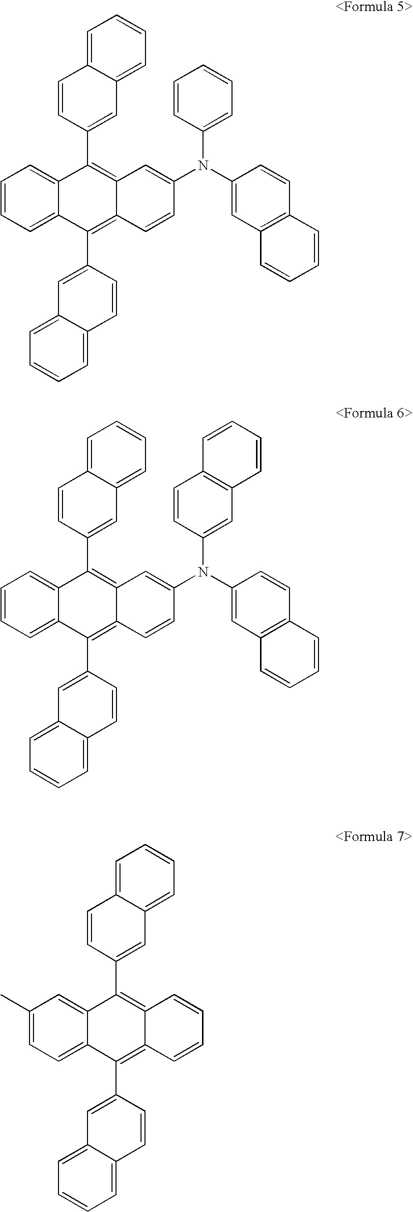

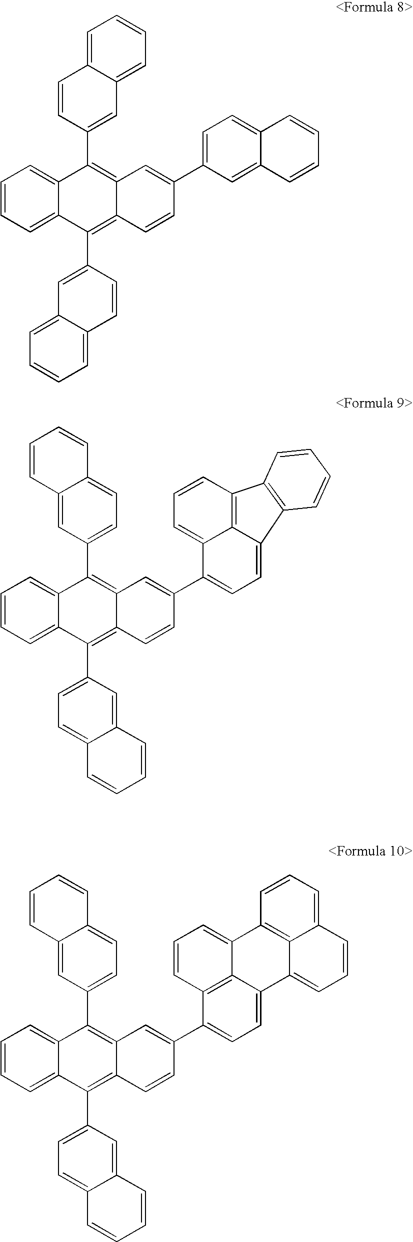

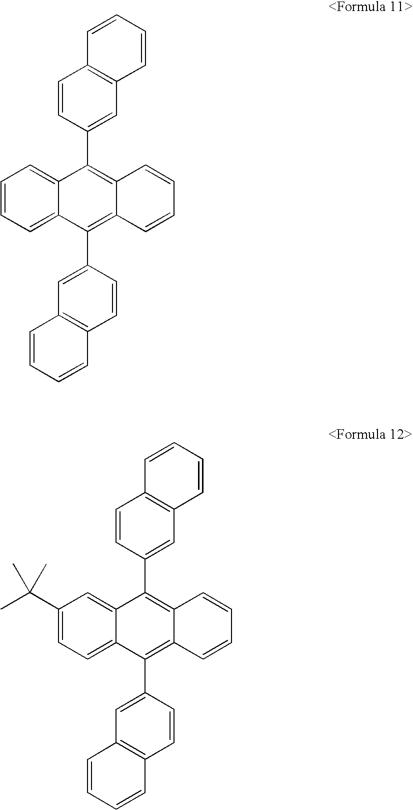

6. The organic light-emitting device of claim 1, wherein the organic layer includes compounds represented by Formulae 2 and 3.

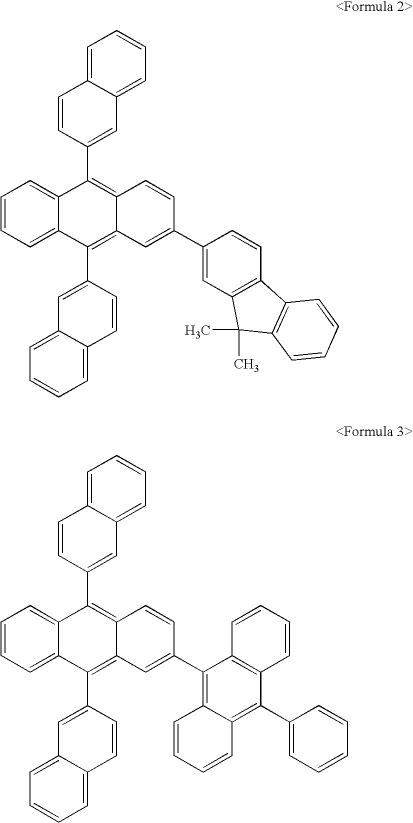

7. The organic light-emitting device of claim 1, wherein the organic layer is an electron transport layer or an electron injection layer.

8. The organic light-emitting device of claim 1, wherein the organic layer is selected from the group consisting of a hole injection layer, a hole transport layer, an electron blocking layer, an emitting layer, a hole blocking layer, an electron transport layer, and an electron injection layer.

9. The organic light-emitting device of claim 1, which has a first electrode/hole transport layer/emitting layer/electron transport layer/second electrode structure, a first electrode/hole injection layer/hole transport layer/emitting layer/electron transport layer/electron injection layer/second electrode structure, or a first electrode/hole injection layer/hole transport layer/emitting layer/hole blocking layer/electron transport layer/electron injection layer/second electrode structure.

10. An organic light-emitting device comprising:
a first electrode;
a second electrode; and
an organic layer interposed between the first electrode and the second electrode, the organic layer comprising an ionic metal complex and one or more anthracene derivative compounds represented by Formula 1 below: 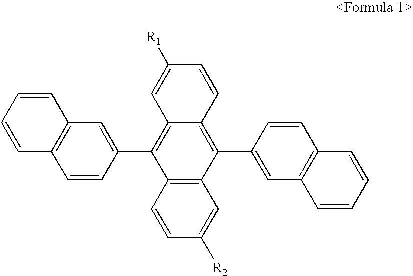
wherein R₁ and R₂ are each independently a hydrogen atom, a substituted or unsubstituted C1-C30 alkyl group, a substituted or unsubstituted C1-C30 alkoxy group, a substituted or unsubstituted C6-C30 aryl group, a substituted or unsubstituted C6-C30 aryloxy group, a substituted or unsubstituted C4-C30 heteroaryl group, a substituted or unsubstituted C6-C30 condensed polycyclic group, a hydroxyl group, halogen, a cyano group, or a substituted or unsubstituted amino group.

11. An organic light-emitting device of claim 1 wherein the organic layer comprises one anthracene derivative compound represented by Formula 1 and the ionic metal complex.

12. The organic light-emitting device of claim 11, wherein the weight ratio of the anthracene derivative compound and the ionic metal complex is 5:95 to 95:5.

13. The organic light-emitting device of claim 10, wherein R₁ and R₂ are each independently one selected from the group consisting of a phenyl group, a C1-C5 alkylphenyl group, a C1-C5 alkoxyphenyl group, a cyanophenyl group, a phenoxyphenyl group, a halophenyl group, a naphthyl group, a C1-C5 alkylnaphthyl group, a C1-C5 alkoxynaphthyl group, a cyanonaphthyl group, a halonaphthyl group, an anthracenyl group, a fluorenyl group, a carbazolyl group, a C1-C5 alkylcarbazolyl group, a biphenyl group, a C1-C5 alkylbiphenyl group, a C1-C5 alkoxybiphenyl group, and a pyridinyl group.

14. The organic light-emitting device of claim 10, wherein R₁ and R₂ are each independently one selected from the group consisting of a phenyl group, an ethylphenyl group, an ethylbiphenyl group, an o-, m- or p-fluorophenyl group, a dichlorophenyl group, a dicyanophenyl group, a trifluoromethoxyphenyl group, an o-, m-, or p-tolyl group, a mesityl group, a phenoxyphenyl group, a dimethylphenyl group, a (N,N′-dimethyl)aminophenyl group, a (N,N′-diphenyl)aminophenyl group, a pentalenyl group, a naphthyl group, a methylnaphthyl group, an anthracenyl group, an azulenyl group, a heptalenyl group, an acenaphthylenyl group, a fluorenyl group, an anthraquinolyl group, a phenanthryl group, a triphenylenyl group, a pentaphenyl group, a hexaphenyl group, and a carbazolyl group.

15. The organic light-emitting device of claim 10, wherein the anthracene derivative compound of Formula 1 is selected from compounds represented by Formulae 2 through 12 below:

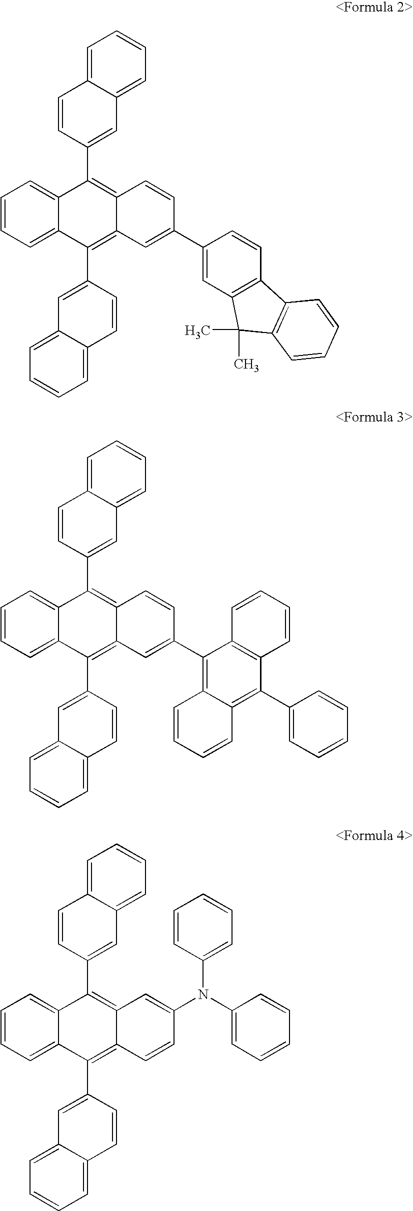

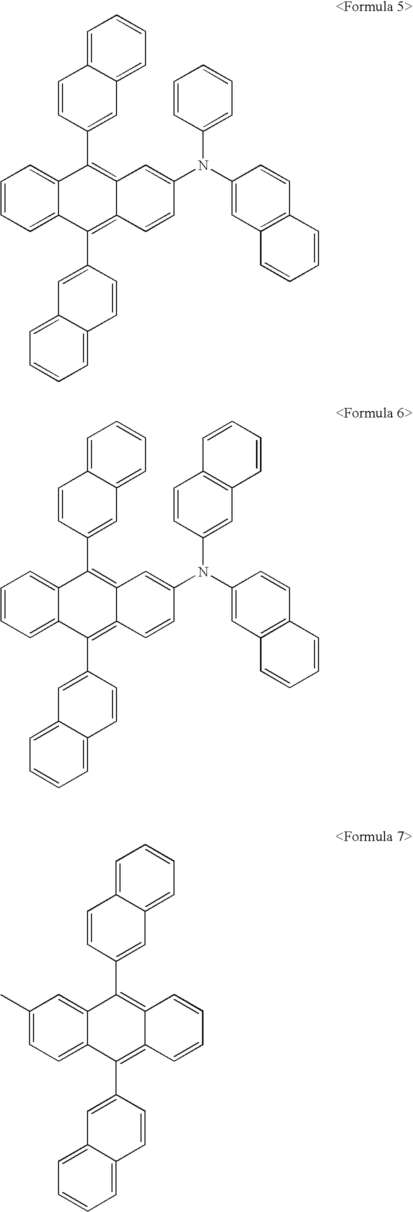

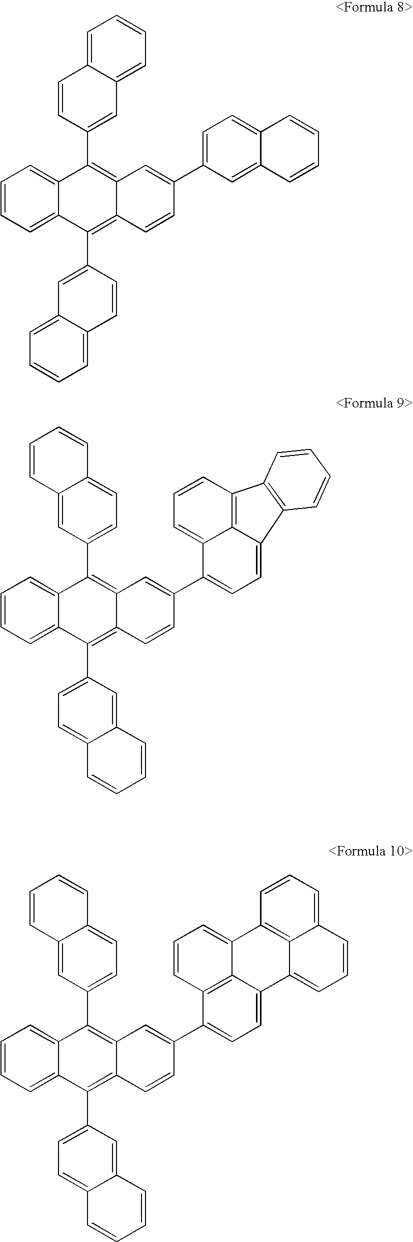

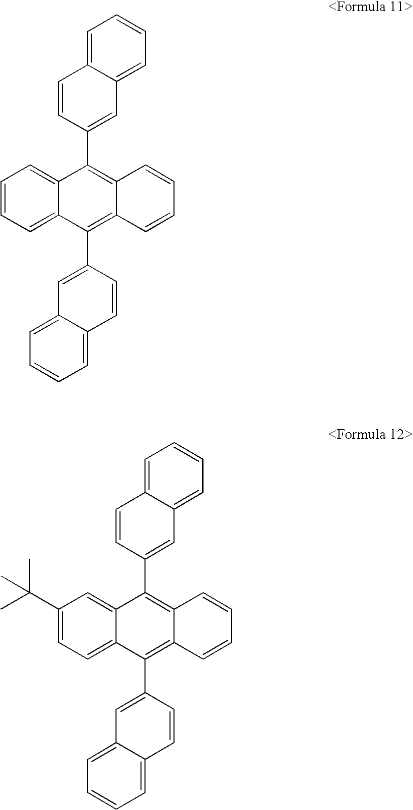

16. The organic light-emitting device of claim 10, wherein the ionic metal complex is a compound represented by Formula 13, 14, or 15 below: 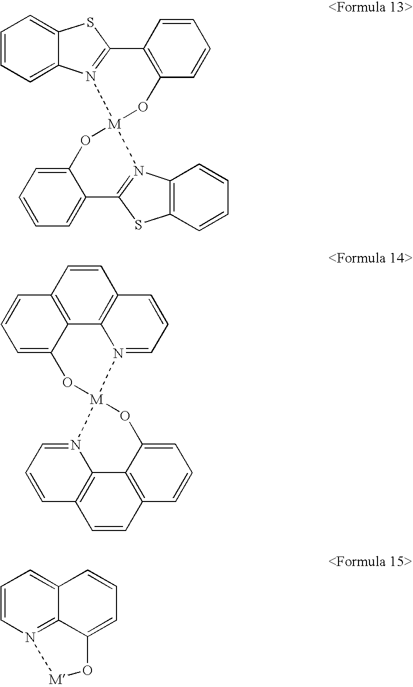
wherein M and M′ are each a monovalent or divalent metal.

17. The organic light-emitting device of claim 11, wherein the organic layer includes a compound represented by Formula 2 and sodium quinolinolate (NaQ):

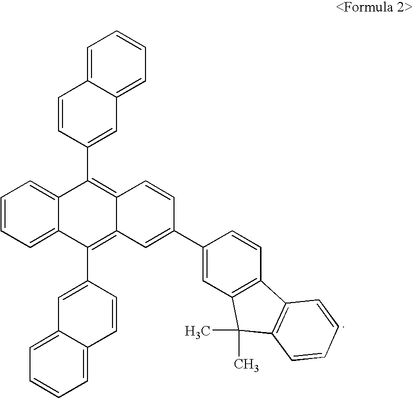

18. The organic light-emitting device of claim 10, wherein the organic layer is an electron transport layer or an electron injection layer.

19. The organic light-emitting device of claim 10, wherein the organic layer is selected from the group consisting of a hole injection layer, a hole transport layer, an electron blocking layer, an emitting layer, a hole blocking layer, an electron transport layer, and an electron injection layer.

20. The organic light-emitting device of claim 10, which has a first electrode/hole transport layer/emitting layer/electron transport layer/second electrode structure, a first electrode/hole injection layer/hole transport layer/emitting layer/electron transport layer/electron injection layer/second electrode structure, or a first electrode/hole injection layer/hole transport layer/emitting layer/hole blocking layer/electron transport layer/electron injection layer/second electrode structure.
